(19) United States
(12) Patent Application Publication
(10) Pub. No.: US 2014/0042140 A1
(43) Pub. Date: Feb. 13, 2014

(54) WELDING PROCESS FOR REPAIR OF THICK SECTIONS

(71) Applicants: Dechao LIN, Greer, SC (US); Jamison William JANAWITZ, Overland Park, KS (US); David Vincent BUCCI, Simpsonville, SC (US); Ronald Lee SOUTHER, Campobello, SC (US); Matthew James O'CONNELL, Mason, OH (US); Srikanth Chandrudu KOTTILINGAM, Simpsonville, SC (US)

(72) Inventors: Dechao LIN, Greer, SC (US); Jamison William JANAWITZ, Overland Park, KS (US); David Vincent BUCCI, Simpsonville, SC (US); Ronald Lee SOUTHER, Campobello, SC (US); Matthew James O'CONNELL, Mason, OH (US); Srikanth Chandrudu KOTTILINGAM, Simpsonville, SC (US)

(73) Assignee: GENERAL ELECTRIC COMPANY, Schenectady, NY (US)

(21) Appl. No.: 13/572,880

(22) Filed: Aug. 13, 2012

(51) Int. Cl. B23K 9/00

(52) U.S. Cl. 219/137 R; 219/136

(57) ABSTRACT

A double-sided tribrid welding technique and apparatus for root pass welding of narrow groove welds. The welding technique utilizes three welding devices. A welding apparatus on a backside of the weld joint may strike an arc on the backside of the weld joint; a welding apparatus on a narrow groove side of the weld may strike an arc within the narrow groove weld joint, while the remaining welding apparatus is a laser that can help establish a keyhole as a common pool of molten metal at the root without burning through the root. Once the arcs are struck substantially simultaneously and the laser is energized, the welding heads move simultaneously, the arc welders assisting in maintaining pre-heat temperature, while minimizing distortion and cracking. Adjusting arc weld parameters provides deformation on completion of the root pass so as to compensate for distortion due to metal shrinkage in subsequent passes.

### FIELD OF THE INVENTION

The present invention is directed to a welding method for joining thick sections, and specifically to a double-sided weld repair utilizing a tribrid laser and tribrid laser welding method for the root pass of a narrow groove weld.

### BACKGROUND OF THE INVENTION

Welding is used to join together sections of metal. Various types of welding exist to accomplish welding of similar metals in thick sections, similar metals in thin sections, dissimilar metals in thin and thick sections and thin sections to thick sections with both similar and dissimilar metals. Different problems arise in all of the various welding arrangements. Various welding techniques have been utilized to make these welds including, but not limited to, for example, electroslag welding, shielded metal arc welding (SMAW), gas tungsten arc welding (GTAW), gas metal arc welding (GMAW), and laser welding.

In thick-section welding, fusion welding is required to fully join the two sections together. One of the challenges of making such welds is the amount of filler metal required to achieve a full penetration weld. It may be necessary to provide a suitable preheat to successfully accomplish such a weld. Even with the preheat, the large amounts of weld metal may result in residual stresses that are so severe that distortion of the parts may occur, particularly as the root or base weld is accomplished, rendering the resulting part unsuitable for use in its intended application. Various solutions have been proposed and have had less than full success. Some of the solutions require special fixturing, while other solutions require further preheat that may adversely affect the grain structure of the material in the heat affected zone (HAZ) or in the base material of the sections adjacent the HAZ. Still other solutions rely on the skill of the welder to provide a successful weld, a high level of skill being required.

What is desired is a method useful for fusion welding of thick sections that can be accomplished by providing a welding process that provides a full penetration weld while maintaining the preheat temperature on both sides of the joint at the root pass and minimizing distortion as a result of the welding process.

### BRIEF DESCRIPTION OF THE INVENTION

The present invention provides a method for joining metal sections while maintaining the preheat and minimizing distortion, comprising the steps of providing a first section having first substantially L-shaped groove face and providing a second section having a second substantially L-shaped groove face. The first groove face of the first section is then aligned against the second groove face of the second section to form a narrow groove in which the metal sections form a butt joint along an interface at a root having a centerline with a groove above the root, wherein the first groove face and the second groove face are separated by a predetermined distance above the butt joint. The narrow groove joint is preheated to a preselected temperature, as required. A first arc welding device, a second arc welding device and a laser welding apparatus are provided. The first arc welding device is placed against the root on a side of the butt joint opposite the groove. The first arc welding device may be aligned with the root centerline, or it may be offset from the root centerline. The second arc welding device is aligned against the root within the groove and offset laterally with respect to the root centerline from the first arc welding device, which is on the opposite side of the root centerline. The laser welding apparatus is aligned so that the laser beam is positioned within the groove and aligned with the root centerline, and the laser beam is aligned with the root centerline, at the interface. Power is simultaneously applied to the first arc welding device to strike an arc, the second arc welding device to strike an arc and the laser welding apparatus establish a stable keyhole while forming a common pool of molten metal at the root which solidifies on cooling to join the first and second groove face at the root without burning through the root. Filler metal is supplied with the first and second arc welding devices. The first and second arc welding devices and the laser welding apparatus are then moved simultaneously relative to the root to form a full penetration weld along a length of the root pass.

Utilization of two arc welding devices heat the joint on both sides so that the preheat temperature of the entire joint can be maintained during the welding. In addition, adjusting the parameter settings to achieve a different filler metal deposition rate on both arc welders will intentionally generate a predicted deformation because of the metal shrinkage during solidification at the root pass so as to compensate for the welding-induced deformation on the following filling passes to make the final weld without distortion. As used herein, the longitudinal direction is the direction of welding, that is the direction that the weld apparatus moves within or parallel to the groove, and the lateral direction is substantially transverse to the direction of welding.

The present invention further provides apparatus for welding a root pass of a thick section weld, referred to as tribrid welding apparatus. The apparatus is successfully utilized in a narrow groove weld joint preparation having a groove side and a side opposite the groove side, the narrow groove weld joint forming a butt joint with an interface at the butt joint. The apparatus includes a first welding device positioned opposite the groove side of the weld joint preparation adjacent the weld butt joint. The first arc welding device may be a GMAW welding torch that strikes an arc on the side opposite the narrow groove weld joint. A second arc welding device is positioned on the groove side of the weld joint preparation adjacent the weld butt joint, and may also be a GMAW welding torch. In at least the initial pass, it is positioned with the torch in the groove so as to strike an arc in the narrow weld groove joint while feeding filler wire to the interface at the butt joint. The second arc welding device physically is positioned longitudinally behind the first welding device with respect to a direction of welding. The first arc welding device and the second arc welding device are positioned on either side of the butt joint with respect to a direction of welding and strike arcs on opposite sides of the butt joint while feeding filler wire to the interface at the butt joint. The third welding apparatus is a laser welding apparatus positioned on the narrow groove side of the weld joint, on the same side of the weld joint as the second arc welding device, emitting a laser beam focused on the interface of the butt joint and positioned between the first arc welding device and the second arc welding device with respect to the direction of welding. The two oppositely-placed arc welding devices and the laser welding apparatus should be synchronized to move at the same speed in the direction of welding. The laser beam should have sufficient power to establish a stable keyhole to penetrate the root face while providing a stable weld puddle. The laser supplements the welding activity of the two arc welders positioned on opposite sides of the root face during welding of the root pass.

After the root pass is formed into the full penetration weld using the tribrid welding apparatus, it is inspected for indications that may be defects using suitable non-destructive testing techniques. After any unacceptable indications are removed, the weld may be completed by filling the groove using any acceptable weld technique that does not severely distort the metal sections being joined.

There are several advantages provided by this technique. First, the technique enables the repair of thick-sectioned parts that otherwise require scrapping, as traditional arc welding of thick-sectioned parts may provide unacceptable distortion.

The technique set forth herein further allows for the use of a narrow groove joint while minimizing the amount of weld filler material required to fill the narrow groove joint.

The technique set forth herein further increases the speed of welding of the joint, which increases productivity providing further advantages over either part replacement or other available welding techniques.

The technique set forth herein further allows for mitigation of weld-induced distortion because of the double-sided welding.

The technique set forth herein further increases the flexibility to deposit different amounts of filler material on either side of the joint by adjusting the filler metal deposition rate, which can be used to make a pre-deformed joint at the root pass.

The technique set forth herein further increases the maintenance capacity of preheat on both sides of the joint when two arc welders are placed on either side of the joint.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a steam turbine part, a N2 hook fit that has experienced crack damage in its fillet region during service.

FIG. 2 depicts a non-narrow groove weld joint preparation and the narrow groove weld joint preparation of the present invention.

FIG. 3 depicts a cross-section of a narrow groove weld joint with the root pass weld completed.

FIG. 4 depicts a cross-section of a narrow groove weld joint along the interface of the weld joint of FIG. 2 depicting the position of the welding apparatus with respect to the welding direction.

FIG. 5 depicts the cross-section of the narrow groove weld joint partially filled with at least one fill pass over the root pass.

FIG. 6 depicts the tribrid laser welding apparatus of the present invention in demonstration mode.

FIG. 7 depicts a demonstration workpiece using the demonstration mode of FIG. 6 after completion of welding, showing both the narrow groove weld joint preparation filled with filler metal on the groove side and the side opposite the groove side, the root pass welded using the tribrid welding technique and the subsequent fill layers welded using a hybrid welding technique.

FIG. 8 depicts a narrow groove weld joint preparation in which the root pass has been welded in accordance with the present invention, and in which identical GMAW parameters are used on both sides of the narrow groove weld joint.

FIG. 9 depicts a narrow groove weld joint preparation in which the root pass has been welded in accordance with the present invention, and in which different GMAW parameters are used on both sides of the narrow groove weld joint, for the correction of distortion as additional passes are applied in the groove.

FIG. 10 is a perspective view of the apparatus of the present invention depicting a first GMAW welding torch on the first side of the demonstration plate and the second GMAW welding torch with a laser welding apparatus on the second side of the demonstration plate.

Wherever possible, the same reference numbers will be used throughout the drawings to represent the same parts.

### DETAILED DESCRIPTION OF THE INVENTION

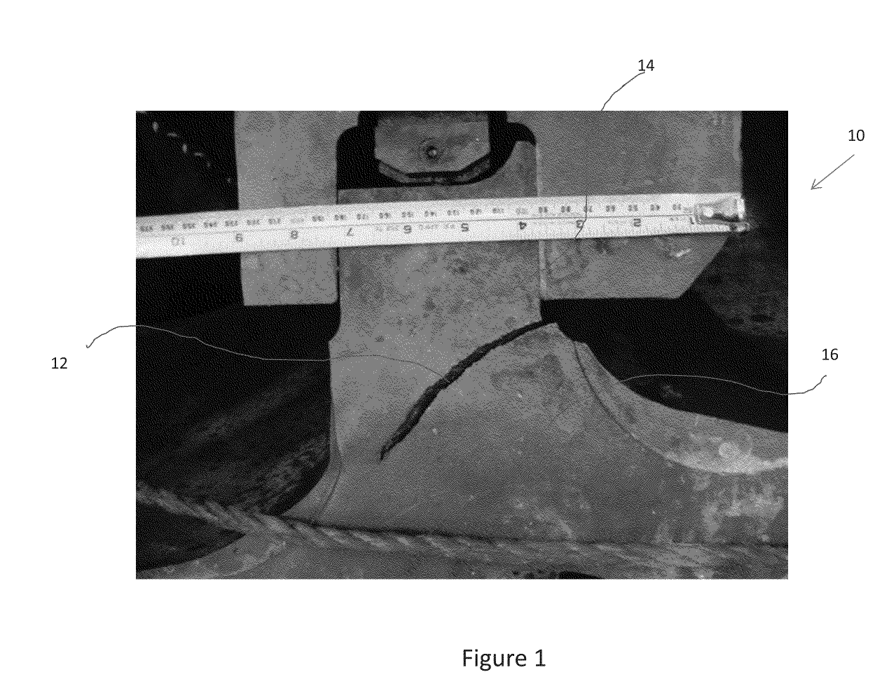

Provided is an exemplary embodiment of the present invention. FIG. 1 depicts a steam turbine N2 hook fit 10 that has experienced cracking due to service in the steam turbine and is exemplary of a thick article whose service life is over if a repair without distortion cannot be accomplished. The only solution to a cracked part such as this N2 hook fit 10 is replacement if no repair is available or if repair results in weld distortion. The steam turbine N2 hook fit 10 is a Cr—Mo—V steel part, although the weld technique is suitable for use for any weld repair in which the part has a thick cross section, and weld distortion due to weld repair using conventional techniques prevents continued use of the part. Traditional available arc welding techniques such as V-groove weld joints or J-groove weld joints are time consuming and require a significant amount of filler metal, while techniques such as submerged arc welding and electroslag welding provide heat input that results in weld induced distortion. These traditional arc welding methods also cannot run at high welding speeds, and defects such as lack of penetration or lack of fusion are common.

Referring to FIG. 1 again, hook fit 10 that has been removed from service has experienced a crack 12, dividing hook fit into a top 14 and a base 16. This defect is typically observed in the fillet region of N2 hook fit 10 as a result of service in a steam turbine. Hook fit 10 is unusable as is, requiring replacement or repair. Suitable repair as an option is less expensive than replacement. Hook fit 10 is a large article having a variable cross section, although the thickness of hook fit 10 in the region of crack 12 is about 3.5 inches. Because of the thickness of the hook fit in the region of crack 12, welding requires preheat. Preheat will be at a preselected temperature, when required, and will be dependent on a number of variables, including material type, material composition and welding parameters. And, in order to minimize heat input that can result in welding-induced distortion, a narrow groove weld joint preparation is required. The challenge to welding using a narrow groove weld joint preparation is to make an effective root pass while maintaining uniform and sufficient penetration at both groove faces in order to avoid defects, such as lack of penetration or burn-through due to insufficient heat input or excessive heat input respectively. Difficulties with even a narrow groove weld joint are that it currently is a difficult weld for a welder to accomplish manually, making the task very operator dependent. The task of accomplishing a narrow groove weld in a thick part such as the N2 hook fit 10 is conducive to automation. This narrow groove weld can best be accomplished by a tribrid welding technique, which utilizes an arc welder, such as a metal inert gas (GMAW) torch, or a tungsten inert gas (GTAW) torch, the GTAW/GMAW welder providing filler metal, and a laser welding apparatus, to weld the root pass within the groove, and a hybrid welding technique to weld subsequent weld passes to fill the groove. However, conventional hybrid welding techniques alone utilizing arc welding and laser welding have been reported to result in hot cracking in multi-pass hybrid welding of thick section austenitic stainless steels, such as the Cr—Mo—V steel utilized in the N2 hook fit, due to high stress levels as additional layers are completed over a root pass.

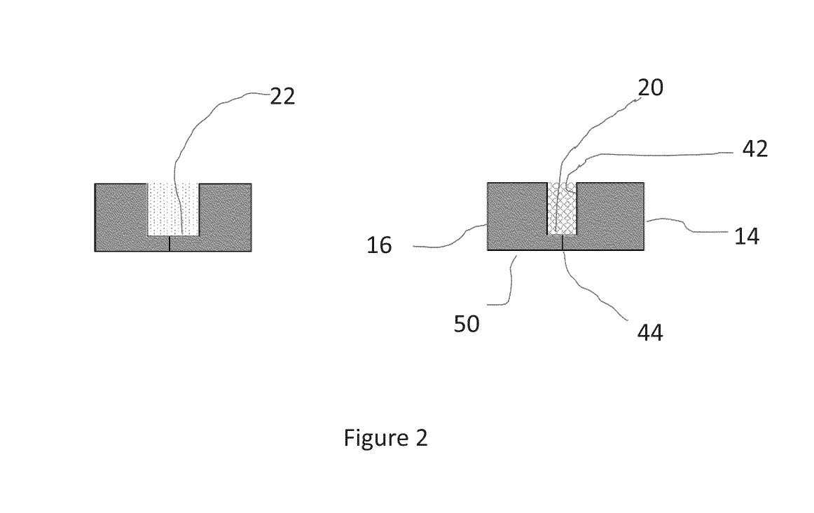

As used herein, a narrow groove weld joint preparation is defined to mean a weld joint having a width of up to about 1 inch, and preferably about ½ inch, and a depth of at least 1 inch to 12 inches. Alternatively stated, a narrow groove weld joint preparation is a weld joint having a ratio of width to depth of 1:2 to 1:24, preferably 1:8 to 1:24, the width being sufficient to receive a welding torch in a gap between the parts to be joined, the current minimum welding torch size being about 11 mm (about 0.43 inches). Thus, based on current minimum welding torch size and access, the weld joint preparation could have a width as small as about 0.4 inches. The difference between a narrow groove weld joint and a non-narrow groove weld joint is best illustrated by reference to FIG. 2 in which a narrow groove weld joint preparation 20 can be compared to a non-narrow groove weld joint preparation 22. As is evident, narrow groove weld joint preparation 20 is more restrictive as compared to non-narrow groove weld joint preparation 22, so that a larger welding torch or device that may have access in non-narrow groove weld joint preparation 22 may not have access in narrow groove weld joint preparation 20, and non-narrow weld groove joint preparation 22 requires more filler metal than narrow weld groove joint preparation 22.

N2 hook fit 10 set forth in FIG. 1 is divided into a first part, top 14, and a second part, base 16, by crack 12, and a weld preparation is machined. In order to accomplish a repair of the article utilizing the present invention, it is first necessary to provide a narrow groove weld joint. It is then necessary to successfully weld the root pass of the weld, which is accomplished in the present invention utilizing a novel tribrid laser welding technique.

The narrow groove weld can be accomplished by first preparing the narrow groove weld joint. This preparation is accomplished by separating top 14 and base 16 of N2 hook fit 10 along crack 12. Once top 14 and base 16 have been separated, there are optional ways of accomplishing the narrow groove weld joint preparation 20. A first optional method is to fabricate a new top 14 from compatible steel, such as Cr—Mo—V steel. New top 14 may have its portion of the corresponding narrow groove weld joint preparation formed in it, such as by machining to form an L-shaped groove face. Base 16 may be machined to form its portion of narrow groove weld joint preparation 20 by forming a corresponding L-shaped groove face. It will be recognized that, depending upon the crack path and machining required to accomplish separation, narrow groove joint preparation in top 14 may require the addition of weld material and subsequent machining in order to form a suitable L-shaped groove face for the narrow groove weld joint preparation 20.

A second optional method is to restore the top 14 after its separation from N2 hook fit 10. Removed top 14 is restored by the same process as base 16, described above, that is, weld metal is added as needed so that the L-shaped groove face for the narrow groove weld joint preparation 20 can be machined to the proper dimensions to mate with base 16, which has its mating L-shaped groove face for narrow groove weld joint preparation 20 formed as set forth as described above.

While the L-shaped groove faces forming narrow groove weld joint preparation are positioned together to form a butt joint, which implies that the faces form a right angle with or at the root, some deviation can be tolerated so that the faces can be offset. Thus the groove faces may form an angle of 80°-90° with the root so that when the faces are butted up against one another, a small gap may exist. Preferably, the L-shaped groove faces in top 14 and base 16 (or their equivalent parts) form an angle of 88-90° with the root so that any gap at an interface 44 between them when the faces are butted against one another is minimal. While narrow groove weld joint preparation is depicted in the figures as a butt joint, it is not so restricted and other well-known joint preparations may be used.

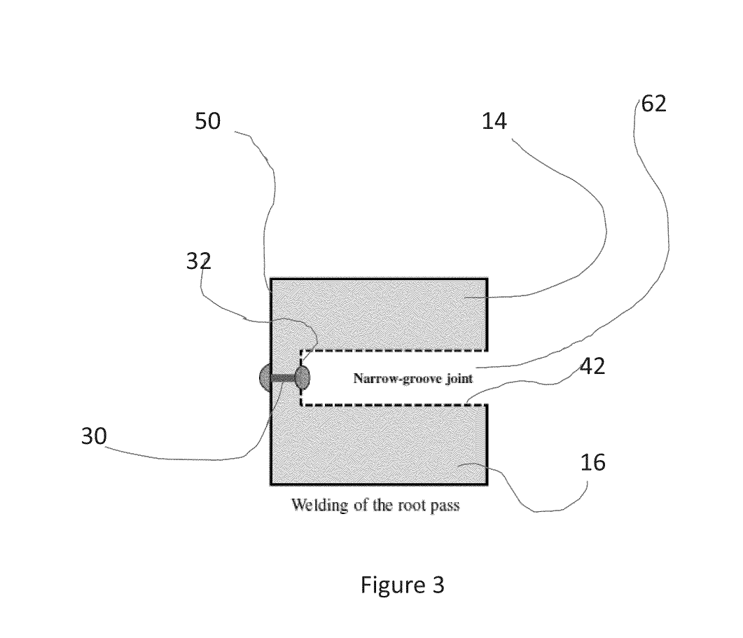

After portions of narrow groove weld joint preparation 20 have been formed in corresponding top 14 and base 16, top 14 and base 16 are positioned adjacent to each other to form a narrow groove weld joint preparation 20 as shown in FIG. 2. Although not shown in FIG. 2, some fixturing may be required to maintain proper fit-up of top 14 to base 16 during the welding process. Depending upon the material being welded, preheat to a preselected temperature or to a preselected temperature range of the base metal forming narrow groove weld joint preparation (here top 14 and base 16) may be required. Preheats for welding selected material systems such as mild steel, low alloy steel, aluminum and superalloys are known in the art and may vary among the systems, and the tribrid welding method of the present invention does not deviate from the prior art in this aspect. Referring to FIG. 3, narrow groove 62 between top 14 and base 16 above the bottom 32 of weld joint is about 11 mm. A root pass 30 may then be formed at the bottom 32 of narrow groove weld joint preparation 20 where top 14 and base 16 abut against each other, that is, where they have their closest proximity or fit-up. The thickness of the root pass weld is about ⅛ inch in the demonstration example with Cr—Mo—V steel, and the thickness of the root pass for any material system will be dependent upon the laser power available, it being understood that at a predetermined welding speed, higher laser power can assist in penetrating a thicker root face.

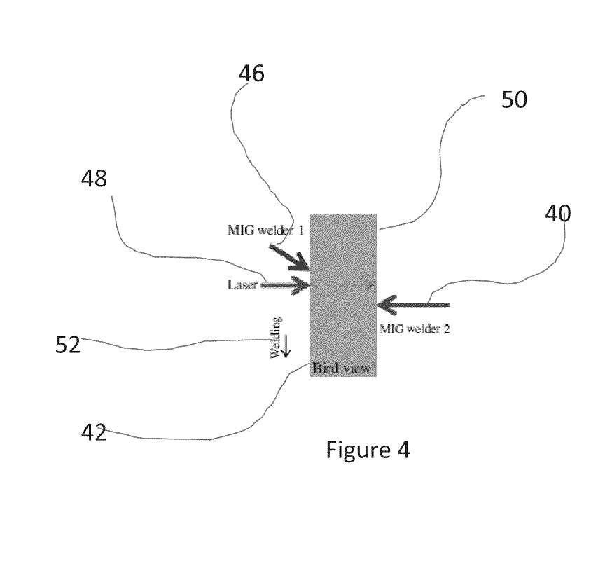

The tribrid laser welding technique used to accomplish the successful welding technique on a root pass is depicted in FIGS. 2-4, while FIG. 4 depicts the bottom 32 of narrow groove weld joint preparation in cross-section. As can be seen, the tribrid laser welding technique uses three welding devices. A first arc welding device 40 is positioned on a narrow groove weld joint preparation on a side 50 opposite groove side of joint preparation 20. Preferably this arc welding device is a GMAW welding torch. A second arc welding device 46 is placed on the groove side of joint preparation 20 opposite interface 44 between base 16 and top 14. Preferably, the second arc welding device also is a GMAW welding torch. A third welding apparatus 48 is positioned on groove side 42 of narrow groove weld joint preparation 20, substantially opposite interface 44 between base 16 and top 14. Third welding apparatus preferably is a laser welding apparatus positioned on the same side of the narrow groove weld joint preparation as second GMAW welding torch. First GMAW torch 40 is positioned on narrow groove weld joint preparation 20 on a side 50 opposite the groove side of joint preparation 20 and interface 44, and thus is offset 180° from laser welding apparatus 48. Second GMAW torch 46 is angularly offset from first GMAW welding torch 40 and behind laser welding apparatus with respect to the welding direction. As depicted in FIG. 4, the orientation of first, and second devices and third welding apparatus 40, 46 and 48 with respect to interface 44 for the root pass is such that second and third welding devices 46 and 48 are on the same side as groove side 42 of weld joint preparation 20, while first welding device 40 is on the opposite side of groove side 42 of weld joint preparation. With respect to interface 44, laser welding apparatus 48 lies between first GMAW torch 40 and second GMAW torch 46.

A fundamental aspect of the invention is that the three welding devices 40, 46 and 48 permit formation of a symmetric weld across the root face as the root pass is welded. This arrangement reduces welding-induced stresses as well as distortion in the root pass. The reduction is both stresses and distortion in the root pass is critical as additional weld metal is added to groove side 42 to complete the weld, this additional weld metal adding further stresses, which, if above a critical value, can result in cracking.

Because of the limited access to interface 44 on groove side 42 due to the geometric configuration of narrow groove weld joint preparation, some welding devices cannot be used on groove side 42. Third welding apparatus 48 preferably is a laser welding apparatus. Laser welding apparatus can be arranged so that the focus of the laser beam is directed onto interface 44 at bottom 32 of narrow groove weld joint on groove side 42, even though laser welding apparatus itself can be located outside of narrow groove weld preparation 20. However laser power must be sufficient to penetrate bottom 32 of narrow groove weld joint preparation. The power required will be dependent on a number of variables, such as welding speed, thickness of the narrow groove weld joint preparation 20 at interface 44, the base material composition as well as other factors. The thickness of the joint preparation may vary from about ⅛ inch to about ½ inch. The welding speed may vary from about 30 inches per minute to 120 inches per minute, again depending on the other variables. The faster the welding speed, the less heat is input into the weld, making it the less likely that the welded article will experience distortion. Of course, the possibility of experiencing a lack of fusion defect also increases. Preferably, a welding speed of 80 inches per minute is preferred. However, a welding speed of about 60 inches per minute has been successfully demonstrated for a N2 hook fit comprising Cr—Mo—V steel. Second arc welding device 46 is limited to a device that can reach interface 44 from groove side 42.

A narrow-groove GTAW welding torch or a GMAW welding torch both are suitable for use as second welding device 46, as both are preferable dimensionally for use in welding a root pass 30 in a narrow groove weld joint preparation 20, although a GMAW welding torch is most preferred. First arc welding device 40 is less restricted as the physical limitations on side 50 opposite groove side are not as severe as on groove side 42, since side 50 opposite groove side is relatively open and exposed. Even though other welding techniques such as shielded metal arc welding and flux-cored arc welding may be available for use as first arc welding device 40, a GTAW welding torch or a GMAW welding torch are preferred. The welding devices, first arc welding device 40, second arc welding device 46, both of which preferably are GMAW/GTAW welding devices, and third welding apparatus 48, preferably a laser welding apparatus, can be automated to move in a coordinated manner, either by fixturing or other computer-related controls and tooling beyond the scope of this invention.

After root pass 30 has been welded, it is inspected for defects which, if present, must be removed before additional filler passes can be added into narrow groove weld joint preparation overlying the root pass. After removal of any defects, the defective area may be repaired using any suitable welding technique. Once again, repairs from groove side 42 will limit the equipment available for use as welding apparatus that can be manipulated within narrow groove weld joint preparation 20. Thus, GTAW welding torch or GMAW welding torch may be required, although it is possible that a laser welding apparatus could be used to accomplish the repair. Repairs made from side 50 opposite groove side again will have more flexibility.

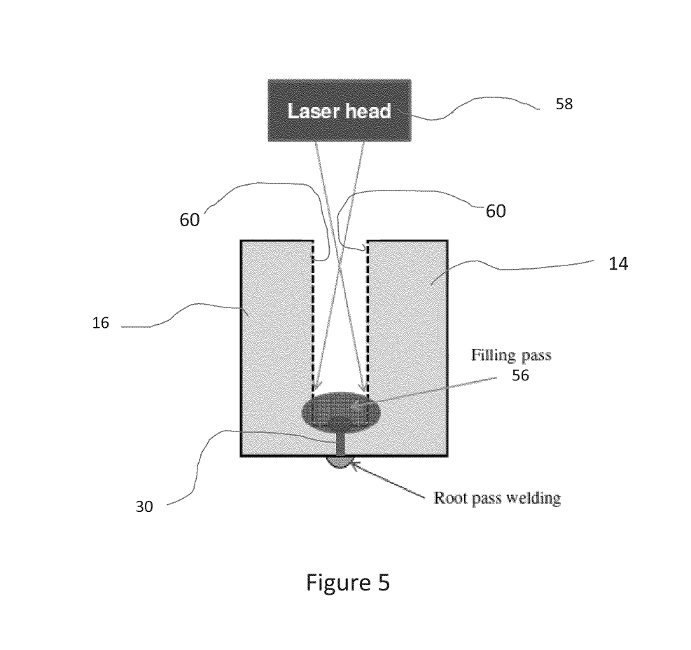

After root pass 30 has been successfully welded and inspected, the narrow groove weld joint preparation 20 may be filled using any technique that can successfully deposit weld metal within joint preparation. One successful technique has been the use of a hybrid laser technique, which utilizes a laser welding apparatus and a GMAW or GTAW welding torch to apply the additional fill passes. The hybrid laser technique differs from the tribrid laser technique in that the hybrid laser technique utilizes a laser welding apparatus with a positive defocused laser beam applied to the weld joint rather than a focused laser beam. The defocused laser welding apparatus operated in conjunction with a GMAW or GTAW welding torch allows the fill pass or passes to be deposited at a higher welding speed, resulting in reduced heat input, beneficially minimizing distortion and residual stress. The laser welding apparatus in the hybrid technique aids the weld by assisting in stabilizing the arc struck by either the GMAW or GTAW welding device, and, it not only strikes the molten weld puddle 56 in filling pass, but also strikes groove faces 60, as shown in FIG. 5. A laser head 58 emitting a defocused beam utilized in a hybrid welding technique is depicted in FIG. 5. Once again, depending upon the base metal, it may be necessary to preheat the narrow groove weld joint and any applied weld metal to a preselected temperature, the preselected temperature determined by the base metal.

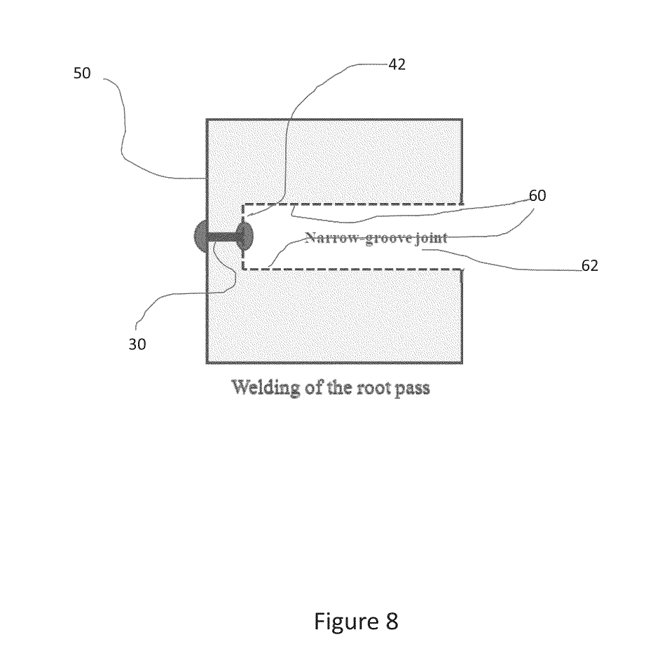

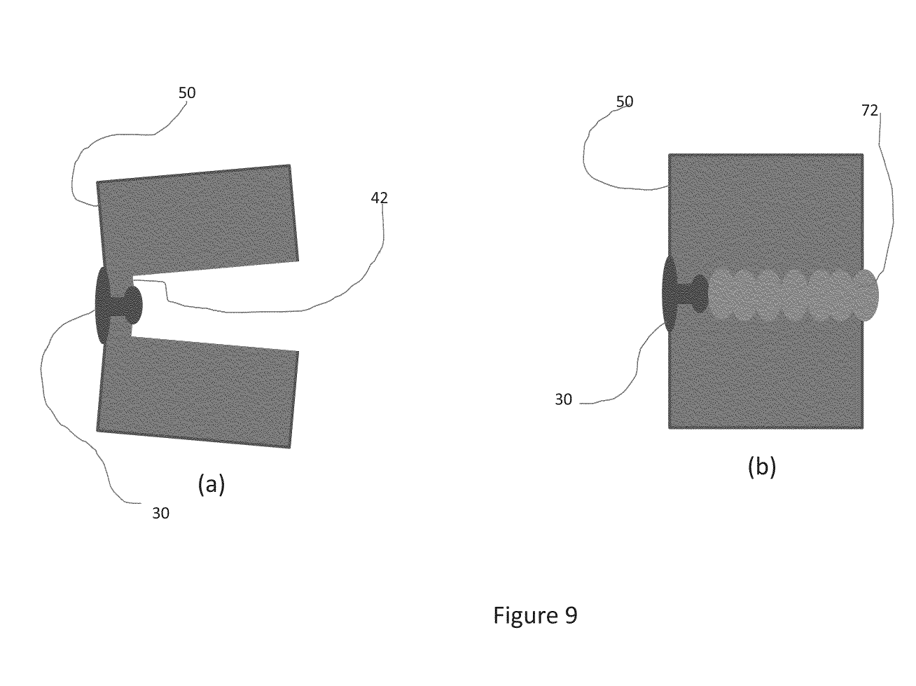

Although third welding apparatus 48 preferably is a laser capable of delivering the required power to maintain a stable keyhole without burning through the root, first and second arc welding devices preferably are consumable electrode GMAW welding torches or non-consumable GTAW arc welding torches, the first and second arc welding devices being selected from the group consisting of consumable electrode GMAW apparatus, non-consumable GTAW welding apparatus, consumable electrode FCAW apparatus and non-consumable plasma arc welding apparatus. When the first and second arc welding devices are GMAW welding torches, the parameters for the GMAW welding torches may be identical to avoid welding induced distortion in the root pass. FIG. 8 depicts a root pass 30 welded using identical GMAW welding parameters. However, weld induced distortion may occur as additional filler passes are added. First GMAW welding torch 40 and second GMAW welding torch 46 may utilize different welding parameters to adjust for solidification-induced deformation along the root pass so that overall distortion of the part can be achieved after completion of the filler passes, even though temporary welding distortion may be experienced by the completed root pass. FIG. 9(a) depicts a completed root pass 30 welded using different welding parameters on either side of the narrow groove weld joint preparation. In FIG. 9(a), only the root pass is completed, and the weld induced distortion predictably occurs as root pass 30 is completed. Note that the amount of metal deposited on the side opposite the groove side 50 is greater than the amount of metal deposited on groove side 42 within the groove as a result of the differing GMAW parameters on either side of the root. As additional filler passes 72 are completed, as depicted in FIG. 9(b), the weld-induced deformation is corrected as the added metal from the additional filler passes solidifies in the narrow groove, resulting in shrinkage and deformation.

Whether identical parameters or different parameters are selected will depend upon the overall part design and weld joint configuration, which will vary.

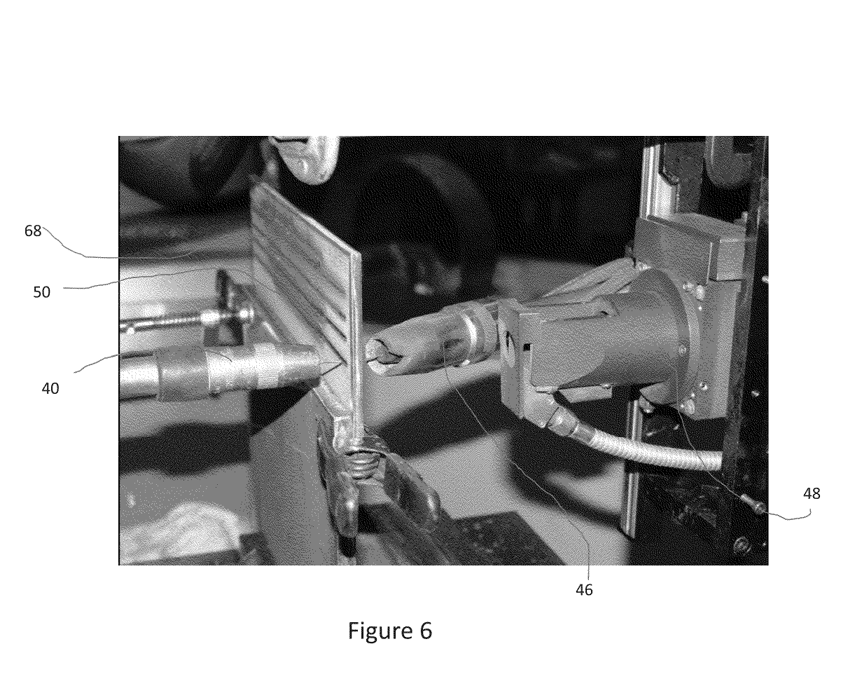

FIG. 6 depicts a demonstration of the tribrid laser technique set forth above. Third welding device 48, a laser head, is depicted on the groove side of joint preparation in workpiece 68 adjacent second welding device 46, a GMAW welding torch. Filler metal extends from the GMAW welding torch in the direction of workpiece 68. A first welding device 40, a GMAW welding torch is depicted on side 50 opposite groove side, and filler metal also extends from this torch in the direction of workpiece 68. Fixturing of workpiece 68 is evident in the background as are electrical connections in the foreground.

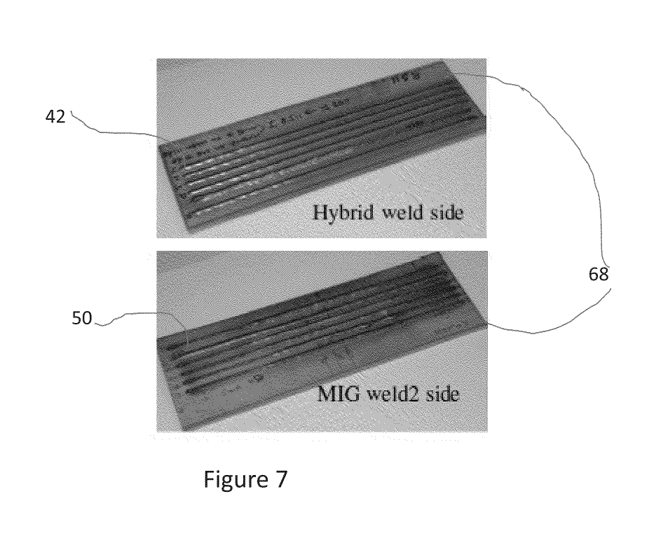

FIG. 7 depicts the completed demonstration of welding of flat, planar workpiece 68. Root pass 30 was completed using the tribrid welding technique. Side 50 opposite groove face shows the back side of the completed root pass 30 welded using a GMAW welding torch. Groove side 42 depicts the completion of welding of narrow groove 62, which has been completed using the hybrid welding technique with a focused laser apparatus and GMAW welding torch of FIG. 6. As can be seen in FIG. 7, workpiece 68 does not disclose any distortion despite the completion of multiple weld joints.

The tribrid laser welding technique is not restricted for use on steels and may be used in other materials systems in which welding may be used to accomplish repair in thick sections, but weld distortion must be minimal. For welding on a Cr—Mo—V steel as described above, the thickness of the steel at interface 44 at bottom 32 of narrow grove weld joint preparation is about ⅛″. The weld metal used for filler metal in the root pass and in subsequent passes to fill narrow groove weld joint preparation is Cr—Mo—V filler wire designated as ER80S-B3L, although other suitable filler wire may be utilized. A preheat of 350° F. is applied to the narrow groove weld joint preparation while welding both root pass and filler passes. A tribrid welding technique is used to form root pass 30. The laser power for a laser beam focused at bottom 32 of narrow groove weld joint penetration along interface 44 is 1.8-4.0 kW, preferably about 3.5 kW, at a welding speed of 60 inches per minute (60 ipm). Groove side 42 welding parameters for a GMAW welding torch 46 at a welding speed of 60 ipm is about 18 volts (V) and 118 amps. It will be recognized that a GTAW welding torch may be substituted for the second GMAW welding torch 46, but different welding parameters may be required to accomplish GTAW welding. Side 50 opposite groove side welding parameters for a first arc welding device 40, a GMAW welding torch, at a welding speed of 60 ipm utilizes the same parameters as used in the second arc welding device, also a GMAW torch, about 18V and 118 amps. It will be recognized that a GTAW welding torch may be substituted for the first GMAW welding torch, but different welding parameters may be required to accomplish GTAW welding. Two arc welding devices, one on either side of the butt joint, assist in maintaining the preselected preheat, preferably about 350° F., so that a satisfactory weld may be achieved. The welding parameters for subsequent fill passes for the Cr—Mo—V steel using a hybrid welding technique employs a defocused layer with a 20 mm positive defocus and, preferably, a GMAW welding torch. The parameters for welding subsequent layers are the same as for the root pass, but the defocused laser at 20 mm positive focus provides a laser beam spot focused at about 20 mm above the layer that is being applied, so the laser beam is spread out to contact groove faces 60.

As noted previously, the welding technique may be used for other material systems, for example for welding of mild steel, stainless steel, low alloy steel, aluminum and superalloys. The selected alloy system being welded may require pre-heating to a preselected temperature. However, the preheat is the same as required for other weld joints of the selected materials employing conventional welding techniques. These preheats are well known to the art and should be applied to the weld joint prior to applying power to strike arcs. The thickness of the test weld example for stainless steel at interface 44, at bottom 32 of narrow grove weld joint preparation, is about ¼″. The weld metal used for filler metal in the root pass and in subsequent passes to fill narrow groove weld joint preparation is stainless steel filler wire designated as 308L, although other suitable filler wire may be utilized. A tribrid welding technique is used to form root pass 30. The laser power for a laser beam focused at bottom 32 of narrow groove weld joint penetration along interface 44 is 3.5 kW, preferably about 4 kW, at a welding speed of 60 inches per minute (60 ipm). The groove side 42 welding parameters for a GMAW welding torch at a welding speed of 60 ipm are about 18V and 118 amps. Side 50 opposite groove side welding parameters for a GMAW welding torch at a welding speed of 60 ipm are about 18V and 118 amps. The welding parameters for subsequent fill passes for the stainless steel using a hybrid welding technique employing a defocused layer with a 20 mm positive defocus and a GMAW welding torch are the same as used to weld the root pass 30, but the defocused laser at 20 mm positive defocus provides a laser beam spot impinged on the previous layer as the layer is applied, so the beam spreads out to contact groove faces 60.

For the stainless steel 304/304L in the test example, no preheat or post heat treatment was utilized, nor is it required. However, other materials, such as for example Cr—Mo—V steel, a preheat and/or a post heat treatment may be required. Whether a preheat or post-weld heat treatment may be required, and the specifics of such heat treatments may be determined by general codes or standards for welding of such materials.

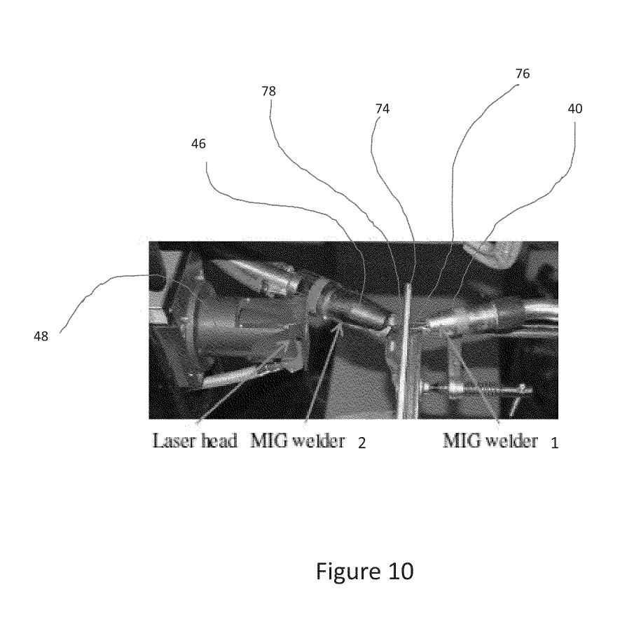

FIG. 10 provides another view of the tribrid apparatus of the present invention in a demonstration mode for welding a demonstration plate. GMAW welding torch 40 is depicted on a first side of demonstration plate 74, with filler metal 76 extending from GMAW welding torch 40 toward demonstration plate 74. Second GMAW welding torch 46 and laser welding apparatus 48 are visible on the second side of demonstration plate 74 with filler metal 78 extending from GMAW welding torch 46 toward demonstration plate 74.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for joining metal sections, comprising the steps of:
providing a first section having first substantially L-shaped groove face;
providing a second section having a second substantially L-shaped groove face;
aligning the first groove face of the first section against the second groove face of the second section to form a narrow weld groove in which the metal sections form a butt joint along an interface at a root having a centerline and a groove above the root wherein the first groove face and the second groove face are separated by a predetermined distance above the butt joint;
providing a first arc welding device and aligning the arc welding device against the root on a side of the butt joint opposite the groove and offset from a first side of the root centerline;
providing a second arc welding device and aligning the second arc welding device against the root within the groove and offset from a second, opposite side of the root centerline;
providing a laser welding apparatus and aligning the laser welding apparatus so that the laser beam is aligned with the root centerline and focused at the interface;
substantially simultaneously applying power to the first arc welding device to strike an arc, the second arc welding device to strike an arc and to the laser welding apparatus, to establish a stable keyhole while forming a common pool of molten metal at the root without burning through the root, while supplying filler metal with the two arc welding devices; and
moving the first arc welding device, the second arc welding device and the laser welding apparatus simultaneously relative to the root to form a full penetration weld along a length of the root pass.

2. The method of claim 1 further including the step of preheating the butt joint to a preselected temperature prior to the step of simultaneously applying power to form the molten pool.

3. The method of claim 1 wherein the step of providing a first arc welding device and a second arc welding device includes selecting the first and the second arc welding devices from the group consisting of consumable electrode GMAW welding devices, consumable electrode GMAW devices, consumable electrode FCAW devices, non-consumable electrode GTAW welding devices and non-consumable plasma arc welding devices.

4. The method of claim 3 wherein the step of providing a first arc welding device includes providing a GMAW welding device, and a second arc welding device includes providing a GMAW welding device, and wherein welding parameters for the first GMAW welding device and the second GMAW welding device are selected to be substantially identical.

5. The method of claim 3 wherein the step of providing a first arc welding device includes providing a GMAW welding device, and a second arc welding device includes providing a GMAW welding device, and wherein welding parameters for the first GMAW welding device and the second GMAW welding device are selected to be different.

6. The method of claim 1 further including the step of inspecting the full penetration weld formed along the length of the root pass to detect defects, removing any detected defects from the root pass and repairing the areas in which defects were removed by subsequent welding.

7. The method of claim 1 further including a step of filling the narrow groove weld joint preparation above the root pass with filler metal.

8. The method of claim 7 wherein the step of filling the groove above the root with filler metal further comprises the steps of
providing an arc welding device above the root pass in the groove;
providing the laser welding apparatus and aligning the laser welding apparatus so that the laser beam is defocused above the root pass and onto the first groove face and the second groove face;
providing power to the laser welding apparatus and the arc welding device while striking an arc with the arc welding device;
feeding weld metal into the groove above the root pass with the arc welding device while heating and partially melting the first groove face and the second groove face above the root pass while moving the arc welding device and the laser welding apparatus simultaneously and in synchronization with respect to the root pass to form a first fill pass weld in the narrow groove weld joint immediately above and with the root pass weld;
repeating the steps of providing the arc welding device, providing the laser welding unit, providing power and feeding weld metal to form additional fill passes in the narrow groove weld joint until the groove is filled with weld metal.

9. The method of claim 8 further including the step of maintaining the narrow groove weld joint and the feed weld metal within a preselected interpass temperature range prior to the step of applying power to the laser welding apparatus and the arc welding device.

10. The method of claim 8 further including the additional step of inspecting the applied fill pass prior to repeating the steps in forming additional fill passes.

11. The method of claim 1 wherein the first substantially L-shaped groove face and the second substantially L-shaped groove face form an angle from 80° to 90° with the root.

12. The method of claim 1 wherein the first substantially L-shaped groove face and the second substantially L-shaped groove face form and angle of 88° to 90° with the root.

13. The method of claim 1 wherein the preselected distance between the first groove face and the second groove face above the butt joint is up to one-half inch.

14. The method of claim 1 wherein the first L-shaped groove face and the second L-shaped groove face extend from 1 inch to 12 inches above the butt joint.

15. The method of claim 1 wherein the thickness of the butt joint at the root is from about ⅛ inch to about ½ inch.

16. The method of claim 1 wherein the thickness of the full penetration weld forming the root pass is from about ⅛ inch to about ½ inch.

17. The method of claim 1 wherein the first arc welding apparatus, the second arc welding device and the laser welding apparatus move at speeds of 30-120 inches per minute with respect to the root.

18. The method of claim 17 wherein the wherein the first arc welding device, the second arc welding device and the laser welding apparatus move at speeds of greater than 50 inches per minute with respect to the root.

19. The method of claim 1 wherein the first section and the second section comprise Cr—Mo—V steel.

20. The method of claim 1 wherein the first section and the second section comprise one of the materials selected from the group consisting of mild steel, low alloy steel, aluminum and superalloys.

21. Apparatus for welding a root pass of a thick section weld, comprising:
a first arc welding device positioned adjacent a narrow groove weld joint preparation on a side opposite a groove side of the weld joint preparation, the first welding device positioned to strike an arc against the weld joint preparation while feeding filler wire to the interface at the butt joint,
a second arc welding device positioned on the side opposite the groove side, the second arc welding device striking an arc in the narrow groove weld joint while feeding filler wire to the weld joint preparation interface in the narrow groove, the second arc welding device positioned longitudinally behind the first arc welding device with respect to a direction of welding;
a third welding apparatus positioned on the groove side of the weld joint preparation further comprising a laser welding apparatus, the laser welding apparatus having a laser beam, the laser beam focused on the interface of the butt joint, the third welding device positioned between the first welding arc device and the second arc welding device with respect to the direction of welding;
wherein the first and second arc welding devices and third welding apparatus are synchronized to move at the same speed in the direction of welding; and
wherein the laser beam from the laser apparatus has sufficient energy to establish a stable keyhole to penetrate the root face while providing a stable weld puddle.

22. The apparatus of claim 21 wherein the first and second arc welding are GMAW torches.
